(19) United States
(12) Patent Application Publication
(10) Pub. No.: US 2011/0023010 A1
(43) Pub. Date: Jan. 27, 2011

(54) RESERVED COMPONENT CONTAINER-BASED SOFTWARE DEVELOPMENT METHOD AND APPARATUS

(76) Inventor: Kook Cheol KIM, Seoul (KR)

Correspondence Address: CHRISTOPHER PAUL MITCHELL, 888 16TH ST., NW, SUITE 800, WASHINGTON, DC, 20006, US

(21) Appl. No.: 12/933,681

(22) PCT Filed: Mar. 12, 2009
(86) PCT No.: PCT/KR09/01239

§ 371 Date: Sep. 20, 2010

(30) Foreign Application Priority Data
Mar. 19, 2008 (KR) 10-2008-0025300

(51) Int. Cl. G06F 9/44

(52) U.S. Cl. 717/104

(57) ABSTRACT

The invention relates to a software development method and apparatus using Reserved Component Container (hereinafter referred to as “RCC”). An RCC-based software development method comprises designing, data storing (repository), information extraction from the repository, program creation, and testing. An RCC-based software development apparatus comprises: an RCC warehouse (201) where an RCC for use in an RCC modeler is stored; an RCC modeler (202), through which a developer makes design information; an RCC program creator (203) which automatically creates, based on the design information made by the developer, a program that can be executed with a program source with reference to a language dictionary; an RCC modeler tester (204) which runs executable programs to check whether the requirements of the developer are properly reflected (e.g., application of the user-made test scenario, providing test functions such as storage, editing, etc., of logs being generated); an RCC modeler manager (205) which stores, changes and deletes design information in the repository and extracts the information therefrom; a language dictionary (206) which is referred to generate a program source out of the final design information in a computer language designated by the developer; program source and executable programs (207) which are created by the RCC program creator; and a repository interface (209) which connects the RCC modeler manager and the repository. RCC-based software development method and apparatus of the invention can be advantageous in that they provide a simple way of checking whether the requirements of the developer are properly reflected in the implementation design step for utilizing a computer in the development of software, through the direct execution of programs using the RCC sequence diagram. Moreover, since there is no need for additional modification or revision of automatically created programs, quality improvement, substantially reduced time period for development, and dramatic cost-cutting are achieved in the development of software.

### TECHNICAL FIELD

The present invention relates to software development method and apparatus using a reserved component container (hereafter, referred to as “RCC”).

### BACKGROUND ART

Software development method is divided into a structural development method and an object-oriented development method, in accordance with the paradigm of modeling the desired system, and UML selected as an object-oriented modeling language standard OMG has been widely used as an object-oriented modeling language.

Typical CASE TOOL based on UML is RSA (Rational Software Architect) by IBM and Together by Delphi, and other tools are in the market. However, theses are difficult to use, except for skilled technician, because the theory is complicated and there are many deign specifications (type of diagram) to make. Further, since the function of creating codes provided by the tools is at the most to automatically create the basic structure of programs, developers (programmers, users, and designers) have to understand again the basically created codes and make a program with reference to the contents designed by UML in order to complete the program.

Large scale software development projects have been continuously increased in the industrial field and the amount of software to maintain for the existing systems in the companies has increases, but the companies are lack of developers (programmers, designers, and users) and have difficulty in bringing up skilled people. Further, UML that is the latest object-oriented modeling method, and CASE TOOL based on UML have a limit in maintaining and dealing with the amount of software increasing in the business environment.

### DISCLOSURE

### Technical Problem

The present invention following an object-oriented theory has been made to solve the problem. It is an object of the present invention to provide an RCC-based software development method and apparatus that supports an easier software development method without directly coding a program by making an RCC sequential diagram (hereafter, referred to ‘design information’) to allow for software development, on the basis of the RCC reflected with various requests of developers in developing the software, provides a debugger function (test) making it possible to easily verify the final software through a test scenario made by the developers, reduces the manufacturing period by sharing design information and reuse to make the final software, by referring to the design information stored in a repository or produced by common developers as well as design information made by the developers, and makes it possible to easily develop a large application system by making it possible to manage design information by networking and produce the final software.

Further, it is another object of the present invention to provide an RCC-based software development method and apparatus that can remove backlog of company information systems in maintaining software and satisfy various request of developers in a short period of time, by correcting design information stored in the repository without directly correcting the final software source.

### Technical Solution

In order to achieve the objects of the present invention, a Reserved Component Container-based software development method includes a design step, a repository step, a repository information extraction step, a program creating step, and a test step, in which the design step creates design information by using an RCC stored in an RCC warehouse and design information made in advance and stored in a repository, by a developer; repository step that stores and changes the design information created in the design step, in the repository; a repository information extraction step that calls the related design information from the repository to produce a desired program; a program creation step creates a program with reference to a language dictionary through the design step or the repository information extraction step (language dictionary for each computer language referred to create and convert the design information into a program); and a test step executes the program created in the program creating step in order to ascertain whether the developer's request are fully reflected in the operation, and analyzes/edits and checks the result.

Further, a Reserved Component Container (RCC)-based software development apparatus includes: an RCC warehouse where an RCC for use in an RCC modeler is stored; an RCC modeler, through which a developer makes design information; an RCC program creator which automatically creates, based on the design information made by the developer, a program that can be executed with a program source with reference to a language dictionary; an RCC modeler tester which runs executable programs to check whether the requirements of the developer are properly reflected (e.g., application of the user-made test scenario, providing test functions such as storage, editing, etc., of logs being generated); an RCC modeler manager 205 which stores, changes and deletes design information in the repository and extracts the information therefrom; a language dictionary which is referred to generate a program source out of the final design information in a computer language designated by the developer; program source and executable programs which are created by the RCC program creator; a repository interface which connects the RCC modeler manager and the repository; and a repository storing the design information.

### ADVANTAGEOUS EFFECTS

According to the present invention, it is possible to reduce the development period and cost, because it is possible to produce desired software only by designing an RCC sequential diagram through a GUI environment familiar to developers, in developing software.

Further, it is easy to perform unit function test, because it is possible to directly verifying the design information made by developers by using an RCC modeler test. It is possible to reduce a period for complementing and testing desired software produced by integrating desired design information produced on the basis of design information verified for each unit.

It is possible to use the made design information in communication, such as a development conference with another user (client of the software, upper developer, co-developer) and checking the user's request, because the design information made by the developers is not a software source.

It is possible to remove backlog in the information systems of companies, when maintaining software of information systems of the companies, which has been continuously increased.

It is easy to calculate timed and range for maintenance, because it is possible to extract addition/change objects with reference to the RCC sequential diagram information designed by the RCC modeler, from the repository, in adding/changing the functions.

It is easy to manufacture a large application system by integrating results of developers, in addition to reusing the produced design information.

### BRIEF DESCRIPTION OF DRAWINGS

FIG. 1 is a diagram illustrating the configuration when one or more RCC-based software development device.

FIG. 2 is a diagram illustrating the configuration of an RCC-based software development device.

FIG. 3 is a diagram showing an embodiment of an RCC internal structure, RCC data type, and an item field.

FIG. 4 is a diagram showing an embodiment of the internal configuration of an RCC warehouse.

FIG. 5 is a flowchart illustrating an RCC-based software development method.

### MODE FOR INVENTION

Hereinafter, embodiments of the present invention will be described in detail with reference to the accompanying drawings.

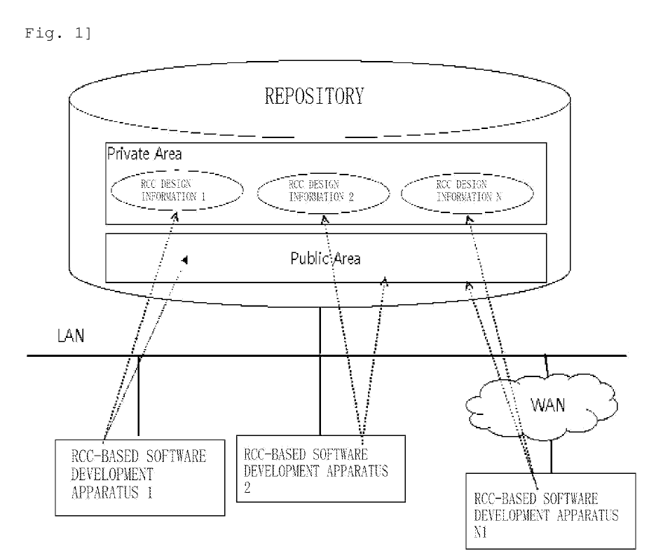

FIG. 1 is a diagram illustrating the configuration of a developing system when one or more RCC-based software development device.

FIG. 1 show the relationship of sharing design information and writing desired software by using an RCC-based software development device (hereafter, referred to as RCC development device). The design information produced by the RCC development device is stored in public area that all the involved developers can access and a private area that the developers individually can access. Authority for access of the private area is given to designated developers, in addition to the producers. Further, the access of the developers to the public area and the private area may be restricted to manage version of the produced design information. The design information shared in the public area can be used by developers, other than the producers, such that the design information can be reused and the access restriction for each area makes it possible to manage of the version of products. Therefore, networking of the RCC development device through the public area and the private area can support a development environment that can more easily make large software.

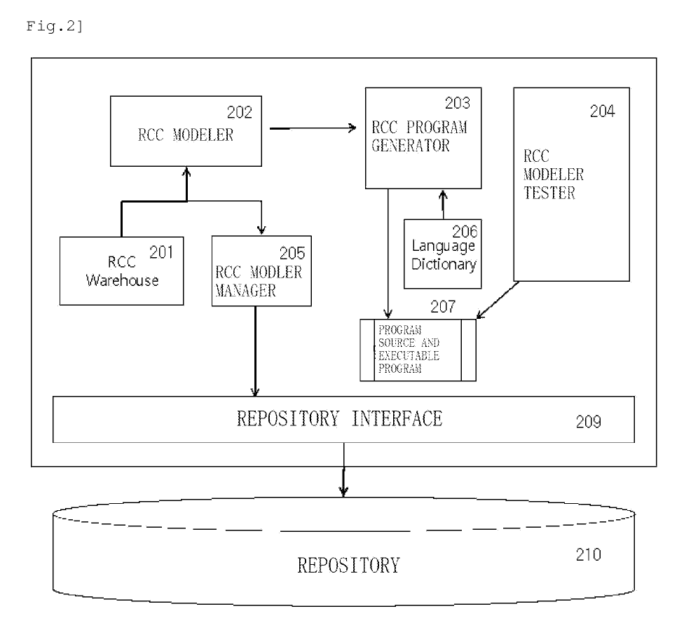

FIG. 2 is a diagram illustrating the configuration of an RCC-based software development device.

RCC-based software development apparatus includes: an RCC warehouse 201 where an RCC for use in an RCC modeler is stored; an RCC modeler 202, through which a developer makes design information; an RCC program creator 203 which automatically creates, based on the design information made by the developer, a program that can be executed with a program source with reference to a language dictionary; an RCC modeler tester 204 which runs executable programs to check whether the requirements of the developer are properly reflected (e.g., application of the user-made test scenario, providing test functions such as storage, editing, etc., of logs being generated); an RCC modeler manager 205 which stores, changes and deletes design information in the repository and extracts the information therefrom; a language dictionary 206 which is referred to generate a program source out of the final design information in a computer language designated by the developer; program source and executable programs 207 which are created by the RCC program creator; and a repository interface 209 which connects the RCC modeler manager and the repository.

Further, the repository 210 where the design information is stored can be operated outside the RCC development apparatus, it is installed and operated together with an RCC development apparatus that is individually used and is not included in a basic RCC development apparatus, when a plurality of RCC development apparatus is used.

The repository may be implemented by a single repository or a hierarchical structure. According to the hierarchical structure, a first repository is installed and operated in the RCC development apparatus or a second repository may be installed and operated outside the RCC development apparatus. That is, the second repository includes the design information stored in the private area and the public area of a plurality of first repositories and the second repository of the designed information of the first repositories is copied by authorized developers. Copy of the design information stored in the first repository is performed manually or by a method designated by the authorized developer. A third repository may be implemented in the same way, and how many hierarchy repositories are structured may be determined by the method and the structure of the desired software development organization.

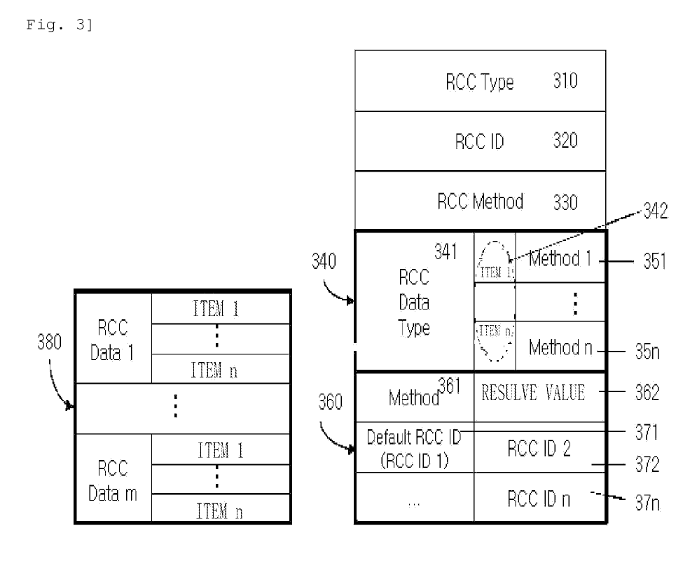

The RCC warehouse and the language dictionary are component made and provided in advance. The RCC warehouse is a warehouse of the RCCs having the structure shown in FIG. 3 and the language dictionary is a reference dictionary for each computer language for converting RCC sequential diagram design information made by the RCC modeler into a program and executable program.

The RCC modeler provides a function that allows the developer to manufacture design information by reflecting the development intention. The design information made by the RCC modeler includes test scenario information that can test the RCC sequential diagram, in addition to the RCC sequential diagram. The test scenario information includes information on input values and input time for necessary conditions in performing work for the test, and where a middle value to be ascertained for verification during the test and an output value produced from the design information and transmitted to the outside are designated. The test scenario information is an example and not limited thereto, and may include information for a test method by a general scenario.

The RCC program generator creates a program source and an executable program (program executing file) with reference to conversion rules provided in the language dictionary on the basis of the design information produced by the RCC modeler.

The RCC modeler tester provides the developer with a test function on the basis of the program source and the executable program which are created by the RCC program generator. In detail, it provides intellectual debugger functions, such as an edit function (test scenario can be made by the RCC modeler and the function is also provided by the RCC modeler), an executing function by a test scenario, analyzing and editing function of executing result, and an unit function, and a test function,

The repository interface is an interface connecting the RCC modeler with the repository and provides a matching function for creating and changing the information designed by the RCC modeler. FIG. 3 is a diagram showing the internal structure of an RCC.

In general, the service configuration of business application is constructed by a three-hierarchical service model to provide service in developing software, and the three-hierarchical service model is composed of a user interface (mainly, screen), a business logic, and data process. In those components, the business logic and the data process has difficulty and complication in developing. The logic configuration processed by the business application may be divided into reference/creation process of data, processing and creating data, deletion process, logic flow control process, calculation process, and edit process of the processed result.

The RCC is designed to allow the developer to easily develop software by reflecting the above processes, and is composed of an RCC type 310, an RCC ID 320, an RCC method 330, an RCC class 340, and an RCC ling pointer 360.

The RCC type is provided to discriminate and define features of the frame of the action that the RCCs have to perform. When selected for the developer to design the business application logic, the RCC type is composed of an RCC type dependent on one business application logic.

The RCC ID selects an RCC required from the developer to design the business application logic and is automatically given an RCC ID for an RCC when designing the entire flow. The given RCC ID may be changed by the developer. Further, the RCC ID processes a designated method and then functions as a reference interface for share of the date value, and is used as a discriminator in creating a program.

The RCC method is a place where detailed actions that the RCC has to is determined in the frame of action basically determined in accordance with the RCC type. For example, in the data reference/creation RCC, the RCC type is data reference/creation, and the basic frame of the RCC type is an RCC that refers to data or creates and processes data, and SQL sentences or File process sentences that are data base process sentences for the data creation/reference are determined in the RCC method.

The RCC class is composed of RCC data type 341, items (item 1, item 2, item 3, . . . item n) 342, and method 351, 352, . . . 35n.

The RCC data type implies the type of RCC data and each item depends on each method. That is, the method 1 depends on the item 1 (the process result value is stored in the item 1). n items and methods exist, respectively, and have one-to-one correspondence. The item is divided into an SQL sentence item used in the corresponding method, a variable item for processing the business application logic, and a temporarily used item. The item used in the SQL sentence of the method is an item defined in defining a table, in which the property of the item (data type and length etc.) depends on the item property in defining the table and is not needed to be specifically defined. The item used as a variable is divided again in an item for processing data in the business application logic and an item used for conditions. Finally, there is a temporarily used item, all the items have defined properties (data type and length etc.), a method is determined for processing data and the item used for the conditions also defines necessary method. As described above, n items and methods are in one RCC to correspond to each other, and the definition is determined by the designer in accordance with the business application logic. The RCC class is executed in an instant type in a computer. FIG. 3 shows an RCC instance 380 including m instances. That is, the RCC instance 380 calls each method that is dependent on each item in the RCC method to the instant of the RCC class, and stores the process result values to each item field.

An RCC link pointer indicates an RCC to be performed next and is composed of one method 361 for determining the next RCC, an executing result value 362 of the method, and n RCC IDs to be processed next by the executing result value after the current RCC is performed. When the designer connects the RCC by using arrows (→) indicating flow between the RCC in one business application logic, an RCC ID to be performed next after performing itself is automatically set in the default RCC ID (RCC ID 1) 371 of the next flow. Thereafter, when a plurality of RCC to be performed after detailed design of each RCC exists, an action corresponding to division condition is defined in the method, and the executing result items (result values) of the method is defined in the item. Thereafter, the RCC IDs to be divided are sequentially defined in accordance with the result value.

The first RCC of the business application is a start RCC, which is not designated by the developer and automatically designated. The process result value (stored in the item) for the item of the RCC data type of each RCC defined in one business application logic can be shared in the business application logic, and the sharing method is implemented by using the RCC ID as an interface. Further, in the business application logic commonly used, the business application logic is commonly defined such that it can be referred to and executed in different business application logic. The designer designs the entire flow of the business application by selecting the RCC in the RCC warehouse to design the processing order of the business application, the action of the RCC is defined in the RCC method in order to design the detailed business application logic that each RCC has to process, in the selected each RCC, and the property is defined in the item. In this process, the RCC method defines the detailed action in a frame defined as the basic action of each RCC, the item is made to be able to define the method for individual item such that it can define the item as well as the action that the item itself can have, such that the business application logic can be designed.

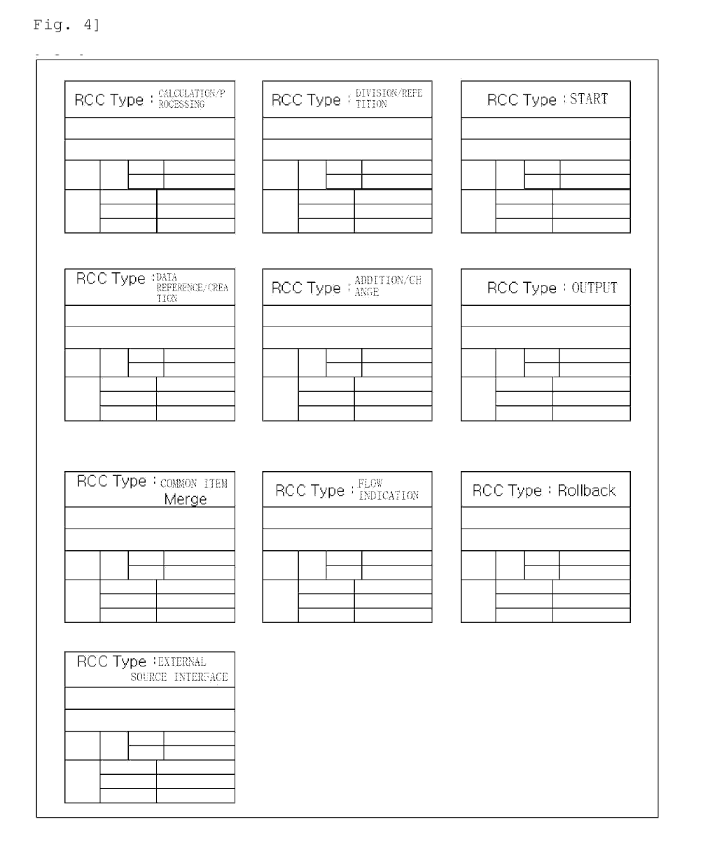

FIG. 4 is a diagram showing an embodiment of the RCC type of an RCC warehouse.

As shown in FIG. 4, an example of the RCC warehouse (only the RCC type is defined and the detailed internal configuration is not included) is composed of RCCs having an RCC structure of calculation/processing, division/repetition, star, data reference/creation, addition/change, output, common item merge, rollback, flow indication, and outside source interface. The RCC having an output RCC type is a typical RCC having a function of output edit for the developer to be able to watch the process result in designing the business application logic, and output edit for sharing the process result by designing a function commonly used in the business application logic. The RCC can be added/changed in accordance with changes in the computer environment, and makes it possible to design the business application logic, using the RCCC in the RCC warehouse.

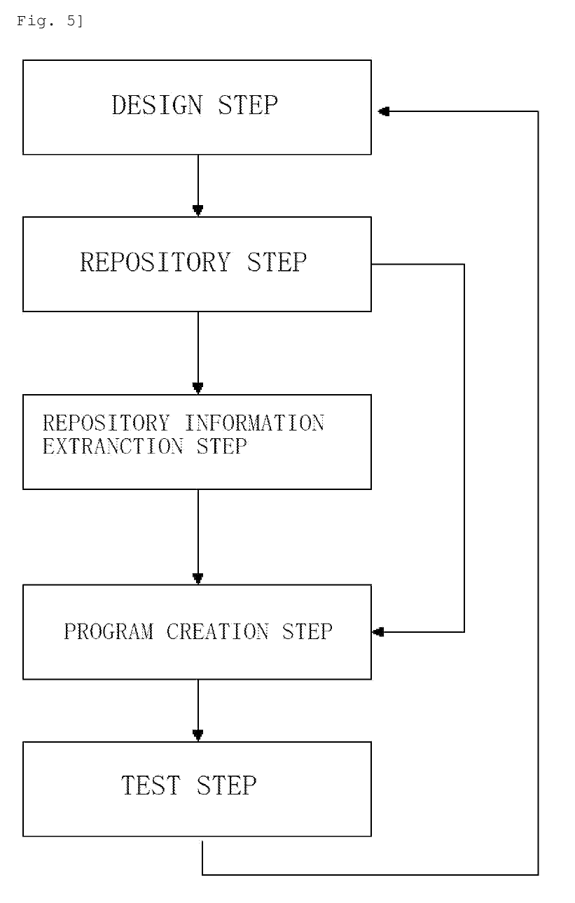

FIG. 5 is a flowchart illustrating the RCC-based software development method.

The RCC-based software development method is composed of design step, repository step, repository information extraction step, program creation step, and test step.

The design step creates deign information by using the RCC stored in the RCC warehouse and design information made in advance and stored in the repository.

The repository step is to store and change the design information created in the design in a repository.

The repository information extraction step is to call the related design information from the repository to produce a desired program.

The program creation step is to create a program with reference to the language dictionary (language dictionary for each computer language referred to create and convert the design information into a program), through the design step or the repository information extraction step.

The test step is to execute the program created in the program creating step in order to ascertain whether the developer's request are fully reflected in the operation, and analyze/edit and check the result.

1. A Reserved Component Container (RCC)-based software development apparatus, comprising:
an RCC warehouse that stores an RCC composed of an RCC type, RCC ID, and RCC method, an RCC class, and an RCC link pointer;
an RCC modeler that makes design information by using the RCC stored in the RCC warehouse by a developer;
an RCC program generator that automatically creates a program source and an executable program with reference to a language dictionary on the basis of the design information made by the developer;
an RCC modeler manager that stores, changes, deletes, and extract the design information in a repository;
a language dictionary that is referred to create a program source in a computer language designated by the developer from the final design information; and
a repository interfaced that connects the RCC modeler with the repository.

2. The RCC-based software development apparatus according to claim 1, further comprising a repository storing the design information.

3. The RCC-based software development apparatus according to claim 2, further comprising an RCC modeler tester which runs executable programs to check whether the requirements of the developer are properly reflected.

4. The RCC-based software development apparatus according to claim 1, wherein the RCC class includes an RCC data type, one or more items, and one or more first method, and
the RCC link pointer indicates an RCC to be performed next and includes a second method for determining the next RCC, a result value of performing the second method, and one or more RCC ID to be processed after performing the next RCC.

5. The RCC-based software development apparatus according to 4, wherein the repository has a hierarchical structure, a first repository is included in the RCC-base software development apparatus, a second hierarchical repository is positioned outside the RCC-based software development apparatus, and the second repository includes design information of the first hierarchical repository.

6. A Reserved Component Container-based software development method, comprising:
design step that creates design information by using an RCC stored in an RCC warehouse and design information made in advance and stored in a repository, by a developer;
repository step that stores and changes the design information created in the design step, in the repository; and
a program creation step that creates a program with reference to a language dictionary (language dictionary for each computer language referred to create and convert the design information into a program).

7. The Reserved Component Container-based software development method according to claim 6, further comprising a repository information extraction step that calls the related design information from the repository to produce a desired program, after the repository step.

8. The Reserved Component Container-based software development method according to claim 6, further comprising a test step that executes the program created in the program creating step in order to ascertain whether the developer's request are fully reflected in the operation, and analyzes/edits and checks the result, after the program creation step.

9. A computer-recordable storing medium that includes a Reserved Component Container-based data structure, wherein a data structure of a f-people reserved component container includes an RCC type, an RCC ID, and RCC method, an RCC class, and the RCC link pointer, an RCC class includes an RCC data type, one or more items, and one or more first methods, and the RCC link pointer indicates an RCC to be performed next and includes a second method for determining the next RCC, a result value of performing the second method, and one or more RCC ID to be processed after performing the next RCC.

10. The RCC-based software development apparatus according to claim 2, wherein the RCC class includes an RCC data type, one or more items, and one or more first method, and
the RCC link pointer indicates an RCC to be performed next and includes a second method for determining the next RCC, a result value of performing the second method, and one or more RCC ID to be processed after performing the next RCC.

11. The RCC-based software development apparatus according to 10, wherein the repository has a hierarchical structure, a first repository is included in the RCC-base software development apparatus, a second hierarchical repository is positioned outside the RCC-based software development apparatus, and the second repository includes design information of the first hierarchical repository.

12. The RCC-based software development apparatus according to claim 3, wherein the RCC class includes an RCC data type, one or more items, and one or more first method, and
the RCC link pointer indicates an RCC to be performed next and includes a second method for determining the next RCC, a result value of performing the second method, and one or more RCC ID to be processed after performing the next RCC.

13. The RCC-based software development apparatus according to 12, wherein the repository has a hierarchical structure, a first repository is included in the RCC-base software development apparatus, a second hierarchical repository is positioned outside the RCC-based software development apparatus, and the second repository includes design information of the first hierarchical repository.

14. The Reserved Component Container-based software development method according to claim 7, further comprising a test step that executes the program created in the program creating step in order to ascertain whether the developer's request are fully reflected in the operation, and analyzes/edits and checks the result, after the program creation step.
